(19) United States
(12) Patent Application Publication
(10) Pub. No.: US 2015/0215228 A1
(43) Pub. Date: Jul. 30, 2015

(54) METHODS, SYSTEMS, AND COMPUTER READABLE MEDIA FOR A CLOUD-BASED VIRTUALIZATION ORCHESTRATOR

(71) Applicant: Sam Eric McMurry, Richardson, TX (US)

(72) Inventor: Sam Eric McMurry, Richardson, TX (US)

(73) Assignee: ORACLE INTERNATIONAL CORPORATION, Redwood Shores, CA (US)

(21) Appl. No.: 14/166,790

(22) Filed: Jan. 28, 2014

(51) Int. Cl. H04L 12/911

(52) U.S. Cl. CPC H04L 47/70; H04L 47/822

(57) ABSTRACT

Methods, systems, and computer readable media for managing network virtualization are disclosed. According to one aspect, a method for managing network virtualization includes, at a virtualization orchestrator comprising a hardware processor and for managing virtual networks within a telecommunications network, receiving virtualization related data from an information concentrator for collecting and analyzing virtualization related information and/or a source other than telecommunications network nodes, determining a network virtualization operation based on the received data, and performing the network virtualization operation.

### TECHNICAL FIELD

The subject matter described herein relates to methods and systems for managing network virtualization. More particularly, the subject matter described herein relates to methods, systems, and computer readable media for a cloud-based virtualization orchestrator of a telecommunications network.

### BACKGROUND

A cloud network can include a large number of computers connected through a communication link, such as the Internet. The ability to run a program on many connected computers within the cloud network can be generally referred to as cloud computing. Cloud computing can cut costs and help users to focus on their core businesses by offering converged infrastructures and shared services. The main enabling technology for cloud computing is virtualization. Virtualization abstracts physical infrastructures and makes them available as software components. By doing that, virtualization not only speeds up network operations and increases infrastructure utilization, but it also improves scalability. Each virtual server can start out by having just enough computing power and storage capacity that the client needs, but when the needs grow, more power and capacity can be allocated to that server, or lowered if needed. Virtualization related information such as network traffic data and/or CPU usages can indicate a demand for redistribution of network resources. The redistribution of network resources can be performed in a semi-dynamic fashion, where operators can interact with the cloud network via Graphic User Interfaces to manually move network components around. However, such set up is inefficient for a telecommunications network, and inadequately prepared for sudden changes in network usages.

Accordingly, there exists a need for methods, systems, and computer readable media for processing and using virtualization related information related to a telecommunications network for efficient management of network resources. More specifically, there exists a need for a cloud-based virtualization orchestrator.

### SUMMARY

According to one aspect, the subject matter described herein may include a method for managing network virtualization. The method includes, at a virtualization orchestrator comprising a hardware processor and for managing virtual networks within a telecommunications network, receiving virtualization related data from an information concentrator for collecting and analyzing virtualization related information and/or a source other than telecommunications network nodes, determining a network virtualization operation based on the received data, and performing the network virtualization operation.

According to another aspect, the subject matter described herein may include a system for managing network virtualization. The system includes a virtualization orchestrator (VO) comprising hardware and for managing virtual networks within a telecommunications network, the VO including a network interface for receiving virtualization related data and a virtualization engine for determining a network virtualization operation based on the received information and for performing the network virtualization operation. The received information is information received from an information concentrator for collecting and analyzing virtualization related information and/or information received from sources other than telecommunications network nodes.

The subject matter described herein can be implemented in software in combination with hardware and/or firmware. For example, the subject matter described herein can be implemented in software executed by a processor. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

As used herein, the term “state information” refers to information pertaining to state of network traffic related to a telecommunications network, state of network topology, state of network virtualization rules, and/or state of applications and products related to the telecommunications network.

As used herein, the term “network virtualization operation” refers to operational commands and/or information related to network resource virtualization, and includes virtualization related information such as network performance indicators, cloud network management information, and/or external cloud network resource information

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a diagram illustrating an exemplary embodiment of a system for managing network virtualization according to an embodiment of the subject matter described herein;

FIG. 2A is a diagram illustrating an exemplary embodiment of a Cloud XG virtualization orchestrator in communication with another virtualization orchestrator via an interface module according to an embodiment of the subject matter described herein;

FIG. 2B is a diagram illustrating an exemplary embodiment of a telecommunications network utilizing multiple virtualization orchestrators for managing network resources according to an embodiment of the subject matter described herein;

FIG. 3 is a message flow diagram illustrating exemplary messaging for managing network virtualization according to an embodiment of the subject matter described herein; and

FIG. 4 is a flow chart depicting an exemplary method for managing network virtualization according to an embodiment of the subject matter described herein.

### DETAILED DESCRIPTION

In accordance with the subject matter disclosed herein, systems, methods, and computer readable media are provided for analyzing virtualization related information related to a telecommunications network for managing network virtualization.

In some embodiments, virtualization related information related to a telecommunications network may be collected and processed by an information concentrator. The information concentrator may also generate processed network virtualization related data based on the received virtualization related information. The processed network virtualization related data can include information related to assigning or removing at least one additional network resource to a network component, information about identifying a trend in network resource usage or requirement, information about predicting future network resource usage or requirements, and information about providing notification of an emergency condition. The processed virtualization related data may be directed to a virtualization orchestrator via an interface module. The virtualization orchestrator may further analyze the processed virtualization related data and generate its own virtualization operations to manage network resources. For example, the virtualization orchestrator may include a rules engine configured to look for characteristic patterns within the received virtualization related data, and determine a virtualization operation based on the patterns found to reallocate network resources.

Reference will now be made in detail to exemplary embodiments of the subject matter described herein, examples of which are illustrated in the accompanying drawings. Wherever possible, the same reference numbers will be used throughout the drawings to refer to the same or like parts.

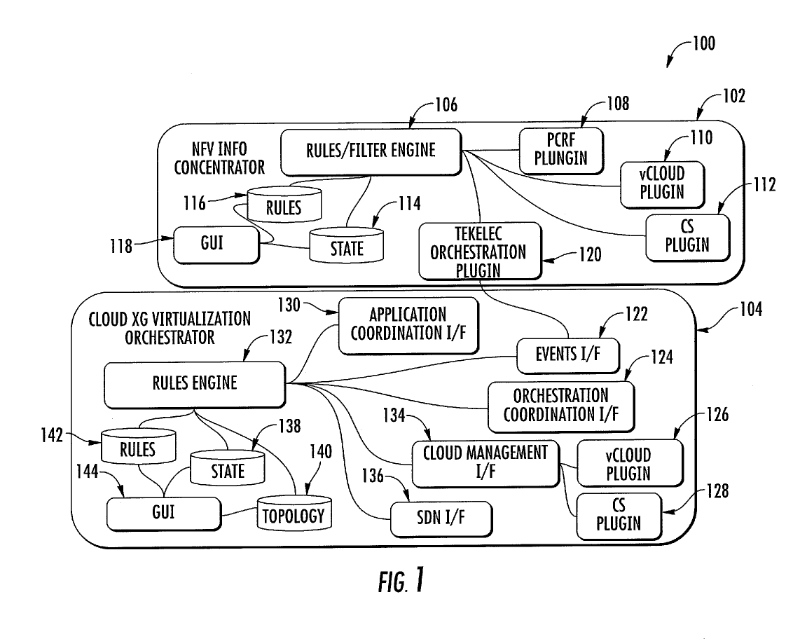

FIG. 1 is a diagram illustrating an exemplary embodiment of a system, generally designated 100, for using processed virtualization related data pertaining to a telecommunications network for managing network virtualization according to an embodiment of the subject matter described herein. As depicted in FIG. 1, system 100 may include a virtualization orchestrator 104 in communication with an information concentrator 102. For example, the virtualization orchestrator may be a Tekelec Cloud XG virtualization orchestrator (VO) 104 configured to receive processed virtualization related data from various applications and products related to the telecommunications network, and may determine network virtualization operations based on the received information. The information concentrator may be a Tekelec network function virtualization (NFV) information concentrator 102 configured to receive and process virtualization related information both from within and external to the telecommunications network. The NFV information concentrator 102 may be capable of determining network virtualization operation commands based on the received information. The NFV information concentrator 102 may communicate with the Cloud XG virtualization orchestrator via an orchestration plugin module such as a Tekelec orchestration plugin 120.

In some embodiments, the Cloud XG VO 104 may receive processed virtualization related data from the NFV information concentrator 102. For example, the NFV information concentrator 102 may receive virtualization related information pertaining to the telecommunications network via a plugin module. In some embodiments, the plugin module may be a Policy and Charging Rules Function (PCRF) plugin 108 configured to supply network performance indicators to the information concentrator 102. Network performance indicators may include information such as network load, network traffic queue depth, and/or latency characteristics on various network elements. Similarly, a cloud management plugin such as a Tekelec vCloud plugin 110 may be configured to direct cloud management information to information concentrator 102. Cloud management information may include information such as processor load on virtual machines, and/or network load and overload information. Furthermore, an information collection module may be configured to direct network information from an external cloud network to the information concentrator 102. For example, information from third party cloud network may be collected and directed to the information concentrator 102 via third party plugin module 112. Likewise, other information collection modules may be utilized by the information concentrator 102 to receive information from analytical applications, products outside the telecommunications network, mobile social depositories, and/or data networks associated with entities such as a power company.

In some embodiments, the received virtualization related information may be processed by a rules/filter engine 106 of the information concentrator 102. For example, the rules/filter engine 106 may be implemented with multiple sets of provision rules, data filters, and/or algorithms for processing received virtualization related information. Furthermore, the rules/filter engine 106 may be in communication with a rules database 116 configured for storing network virtualization operation rules, and/or a state database 114 configured for maintaining network state information. The rules/filter engine 106 may perform simple data filtering to the received information in conjunction with the rules and state information supplied by the rules 116 and state 114 databases. In other embodiments, the rules engine 106 may apply specific algorithms to the received virtualization related information. For example, signal processing and/or machine learning algorithms may be applied by the rules/filter engine 106 to analyze the received information, and characteristic patterns of the received information may be detected and utilized for determining network virtualization operations. In addition, the NFV virtualization concentrator 102 may include a Graphical User Interface (GUI) module 118 configured for interaction with an ender user. For example, the ender user may receive system status information from the GUI module 118, as well as entering network virtualization operation commands to the rules/filter engine 106. In some embodiments, the processed virtualization related data may be directed to the Cloud XG VO 104.

In some embodiments, the rules/filter engine 106 may also determine a network virtualization operation based on the received virtualization related information. For example, the rules/filter engine 106 may apply a signal processing algorithm to the received virtualization related information, and detect or catch a characteristic pattern which can indicate an upcoming network overload. The rules/filter engine 106 may determine or generate a network virtualization operation based on the detected pattern, and advises a virtualization orchestrator to take actions to compensate for the upcoming network overload.

In some embodiments, the determined network virtualization operation and processed virtualization related data may be directed to the Cloud XG virtualization orchestrator 104 via an interface plugin module. For example, upon learning that a network overload may be imminent, the NFV information concentrator 102 may direct the network virtualization operation to the Cloud XG virtualization orchestrator 104 via a Tekelec orchestration plugin module 120 configured for bi-directional communication between the information concentrator 102 and the virtualization orchestrator 104. The Tekelec orchestration plugin module 120 may transmit virtualization operation commands to the virtualization orchestrator 104 as well as feeding topology information back to the information concentrator 102.

In some embodiments, the Cloud XG virtualization orchestrator 104 may receive the network virtualization operation via an interface module of its own. As shown in FIG. 1, the Tekelec orchestration plugin 120 may be connected to an events interface module 122 of the Cloud XG virtualization orchestrator 104. The events interface module 122 may be configured as a bi-directional interface module supplying processed virtualization related data and network virtualization operations to the Cloud XG virtualization orchestrator 104, and direct messages such as network coordination commands back to the NFV information concentrator 102. A network virtualization operation may be received by the events interface module 122 and then forwarded to a rules engine 132 of the Cloud XG virtualization orchestrator 104.

In some embodiments, the rules engine 132 may be connected to a rules database 142 which may be configured to store network virtualization rules, a state database 138 configured for maintaining network state information, and/or a topology database 140 configured for maintaining network topology information. Furthermore, the rules engine 132 may be connected to a Graphical User Interface (GUI) 144 configured to provide network status information to an end user.

In some embodiments, the network virtualization operation generated by the NFV information concentrator 102 may be further processed by the Cloud XG virtualization orchestrator 104 to determine a new network virtualization operation. The rules engine 132 within the Cloud XG virtualization orchestrator 104 may generate a new network virtualization operation based on the received virtualization operation, by applying its own algorithms in conjunction with network virtualization rules supplied by the rules database 142, network state information from the state database 138, and/or network topology information from the topology database 140. For example, the NFV information concentrator 102 may transmit a network virtualization operation to the Cloud XG virtualization orchestrator indicating an upcoming 30% overload on one of the network component, and calls for allocating additional switches and storage resources to compensate the overload condition. Upon reviewing the current state and topology of the network, the rules engine 132 may determine a new network virtualization operation which directs the network not to allocating any resources for that overload condition, because there are other more urgent needs within the network demanding the same resources.

In some embodiments, the new network virtualization operation generated by the rules engine 132 may be directed to various applications and products within the telecommunications network, via an application coordination interface module 130. For example, the application coordination interface module 130 may be a PCRF plugin module configured to interact with applications and products within the telecommunications network. The PCRF plugin may be used to control topology and provisioning configurations to the various network resources within the telecommunications network. In addition, the PCRF plugin may be configured to be a bi-directional interface module and supply network performance indicators such as processor and disk usage or network traffics back to the rules engine 132.

In some embodiments, network virtualization operations may be directed to a Software Defined Networking (SDN) interface module 136 configured for control network traffics. Through the SDN interface module 136 the rules engine 132 may transmit network virtualization operations directly to network hardware resources without having to physically access them.

In some embodiments, network virtualization operations may be directed to other telecommunications networks via a cloud management interface module 134. Sometimes the Cloud XG virtualization orchestrator 104 may wish to establish communication with a cloud network that does not utilize an orchestrator. The cloud management interface module 134, coupled with a cloud management plugin module, may provide the means for network communication and virtualization operations between cloud networks. For example, the cloud management interface module 134 may be coupled with a vCloud plugin module 126, and the vCloud plugin module 126 may be configured to collect cloud management related information such as processor load on virtue machines and/or network traffic information from another cloud network. Similarly, a third party cloud service (CS) plugin module 128 may be coupled with the cloud management interface module 134 and configured to collect information from third party information cloud networks. It will be appreciated that cloud management interface 134 may be coupled with plugin modules not depicted via additional and/or different interface modules.

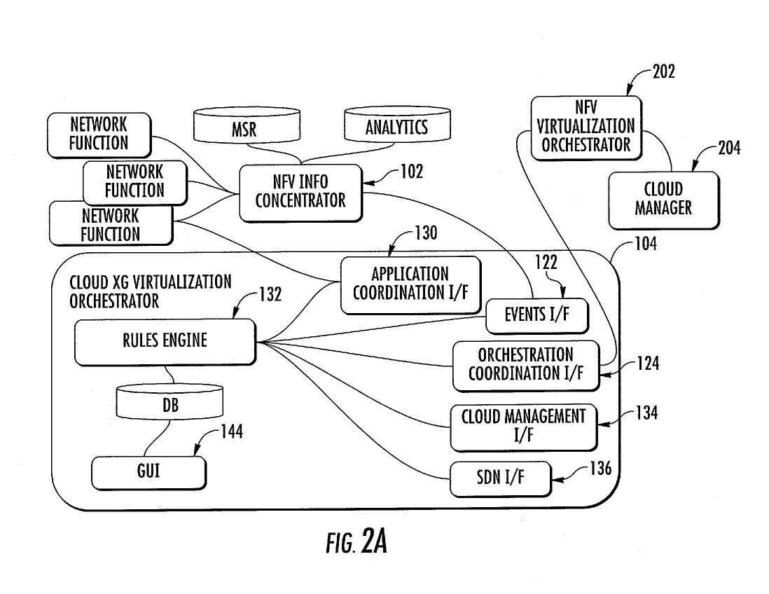

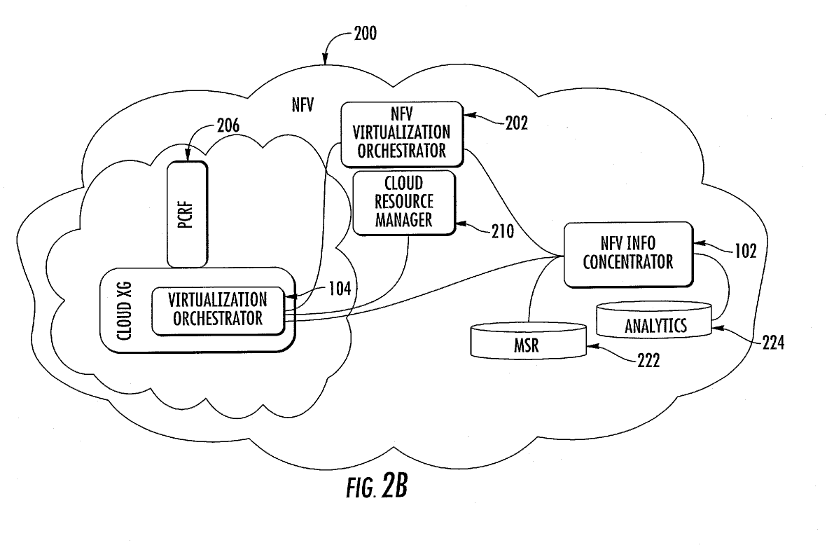

In some embodiments, the rules engine 132 may direct the network virtualization operation to an orchestration coordination interface module 124 configured for bi-directional communication with a second virtualization orchestrator managing a different or larger telecommunications network. For example, the rules engine 132 may direct network orchestration operations and service requests to the second virtualization orchestrator, which may be managing a different and/or larger cloud network, via the orchestration coordination interface module 124, and receives back status information on the larger cloud network. As illustrated in FIG. 2A, the Cloud XG VO 104 may be in communication with a NFV virtualization orchestrator 202 via the orchestration coordination interface module 124. The NFV VO 202 may receive network virtualization operations and/or processed virtualization related data from the rules engine 132 of the Cloud XG VO 104, and the NFV VO 202 may be configured to further process the received data, or perform the virtualization operations via a cloud manager module 204. In other embodiments, the Cloud XG virtualization orchestrator 104 may be implemented as a main virtualization orchestrator managing an entire telecommunications network, and the orchestration coordination interface module 124 may be configured to interface with lesser virtualization orchestrators for managing parts of the network.

While FIG. 1 depicts Cloud XG VO 104 communicating with (e.g., receiving processed virtualization related data from) an information concentrator 102, it will be appreciated that Cloud XG VO 104 may also communicate with other products or applications depicted and/or not depicted related to the telecommunications network via additional and/or different interfaces. It will also be appreciated that Cloud XG VO 104 may include fewer, additional, and/or different modules and/or components.

FIG. 2B is a diagram illustrating an exemplary embodiment, generally designated 200, of a telecommunications network utilizing multiple virtualization orchestrators for managing network resources according to an embodiment of the subject matter described herein. As illustrated in FIG. 2B, exemplary embodiment 200 may be a network function virtualization (NFV) cloud network operating one or more virtualization orchestrators for managing network resources. For example, a NFV virtualization orchestrator 202 may be configured to manage an entire cloud network. In addition, a product or application specific virtualization orchestrator such as the Tekelec Cloud XG virtualization orchestrator 104 may be configured to manage Tekelec specific products. The Cloud XG virtualization orchestrator 104 may manage Tekelec products more efficiently because it has architectural and business rules implemented specifically for Tekelec products. For example, a Policy and Charging Rules Function (PCRF) 206 may have three functions within itself which need to be connected in certain ways and certain ratios, and the Cloud XG virtualization orchestrator 104 is configured to specifically accommodate that type of system requirement.

In some embodiments, the NFV information concentrator 102 may be in direct communication with both the NFV virtualization orchestrator 202 and the Cloud XG virtualization orchestrator 104, thus directing virtualization related information and network virtualization operations to both orchestrators. The NFV information concentrator 102 may receive information from a MobileSocial™ repository (MSR) 222 and/or an analytics module 224. The MSR 222 may include a high-throughput database which enables operators to collect large volumes of subscriber and relevant network data based on the latest advances in big data technology. MSR 222 may also accept real-time feeds from multiple network sources without any service impacts to determine subscriber behavior, norms, preferences and social connections. Furthermore, the MSR 222 may get information from any source, including other nodes and nodes that use other protocols. For example, switches, gateways, routers, and signaling transfer points may provide MSR 222 with information about the network and its performance, including indicators of failure and congestion, identification of traffic patterns etc. The analytics module 224 may supply virtualization related information related to subscriber behaviors, norms, preferences, and/or connections to the NFV information concentrator 102. For example, the analytics module 224 may draw inferences between subscriber individual behaviors, subscriber group behaviors, and/or network status. Analytical data, such as a particular subscriber demographic, is responsible for a large percentage of traffic during peak congestion times may be transmitted to the NFV information concentrator 102. The NFV information concentrator 102 may then determine a network virtualization operation which directs the telecommunications network to offer subscribers in that demographic discounted data rates during off-peak houses, in order to ease congestion.

In some embodiments, as shown in FIG. 2B, the Cloud XG virtualization orchestrator 104 may communicate directly with the NFV virtualization orchestrator 202. For example, network virtualization operations generated by the Cloud XG virtualization orchestrator 104 may be directly received and performed by the NFV virtualization orchestrator. In other embodiments, the Cloud XG virtualization orchestrator 104 may be in communication with a cloud resource manager 210. The cloud resource manager 210 may be configured to directly manage the network resources. It knows the capabilities of the hardware, knows what virtual machines can run on it, and may manage the network components mechanically.

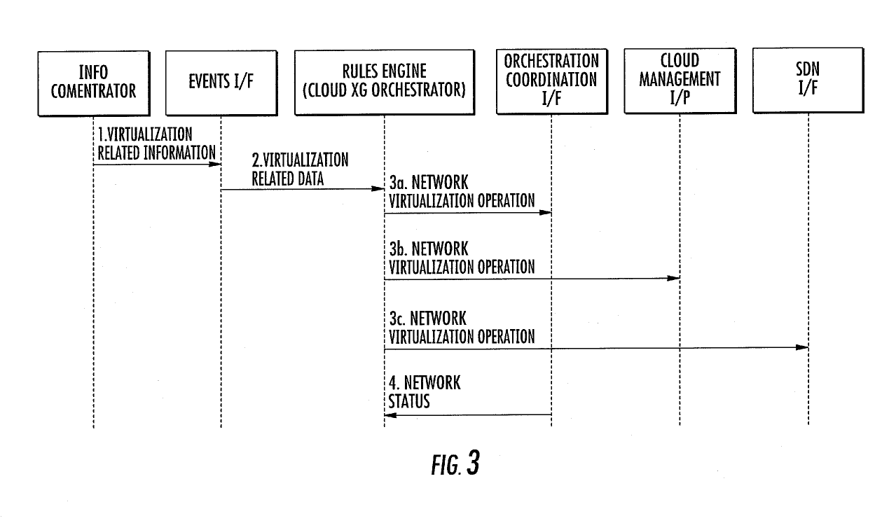

FIG. 3 is a message flow diagram illustrating exemplary messaging for receiving and analyzing virtualization related information in a telecommunications network according to an embodiment of the subject matter described herein. At step 1, virtualization related information related to the telecommunications network may be processed at the NFV information concentrator 102 and then forwarded to an interface module. In some embodiments, the information concentrator 102 may generate network virtualization operations using the processed virtualization related data. For example, the information concentrator 102 may include a rules/filter engine 106 implemented with multiple sets of provision rules, data filters, and/or algorithms for processing received virtualization related information. In some embodiments, the rules/filter engine 106 may perform simple data filtering to the received virtualization related information. In other embodiments, the rules engine 106 may apply specific algorithms to the received virtualization related information. For example, signal processing and/or machine learning algorithms may be applied by the rules/filter engine 106 to analyze the received information, and characteristic patterns of the received information may be detected and utilized for determining network virtualization operations. The processed virtualization related data and network virtualization operations may then be directed to the Cloud XG virtualization orchestrator via an interface module.

In some embodiments, as illustrated in step 2, an events interface module 122 may be utilized to direct the processed virtualization related data and network virtualization operations to a rules engine 132 associated with the Cloud XG VO 104. The events interface module 122 may be configured as a bi-directional interface module supplying network related information to the Cloud XG VO 104, and directing messages such as network coordination commands back to the NFV information concentrator 102. Upon receiving the processed virtualization related data and network virtualization operations, the rules engine 132 may generate new network virtualization operations for managing network resources.

At step 3a, network virtualization operations may be directed to another virtualization orchestrator via the orchestration coordination interface 124 module. In some embodiments, the Cloud XG virtualization orchestrator 104 may be in communication (e.g., receiving and/or forwarding network data) with another virtualization orchestrator configured to manage a different and/or larger telecommunications network. For example, network virtualization operations and/or service requests generated at the Cloud XG VO 104 may be directed to the NFV VO 202 for managing the entire NFV cloud network 200. In some embodiments, as illustrated in step 4, the orchestration coordination interface module 124 may also be configured to transmit network status information from the NFV VO 202 back to the Cloud XG VO 104.

In some embodiments, as illustrated in step 3b, the Cloud XG VO 104 may direct network virtualization operations to other telecommunications networks via a cloud management interface module 134. For example, sometimes the Cloud XG VO 104 may wish to establish communication (e.g., receiving and/or forwarding network data) with a cloud network that does not utilize a virtualization orchestrator. The cloud management interface module 134, coupled with a cloud management plugin module, may provide the means for network communication and virtualization operations between the cloud networks. For example, the cloud management interface module 134 may be coupled with a vCloud plugin module 126, and the vCloud plugin module 126 may be configured to collect cloud management related information such as processor load on virtue machines and/or network traffic information from another cloud network. Similarly, third party cloud service plugin module 128 may be coupled with the cloud management interface module 134 and configured to collect information from third party cloud networks. It will be appreciated that cloud management interface module 134 may be coupled with plugin modules not depicted via additional and/or different interface modules.

Similarly, as illustrated in step 3c, the Cloud XG VO 104 may direct network virtualization operations to a Software defined Networking (SDN) interface module 136 configured for control network traffics. Through the SDN interface module 136 the Cloud XG VO 104's rules engine 132 may transmit network virtualization operations directly to network hardware resources without having to gain physical access first.

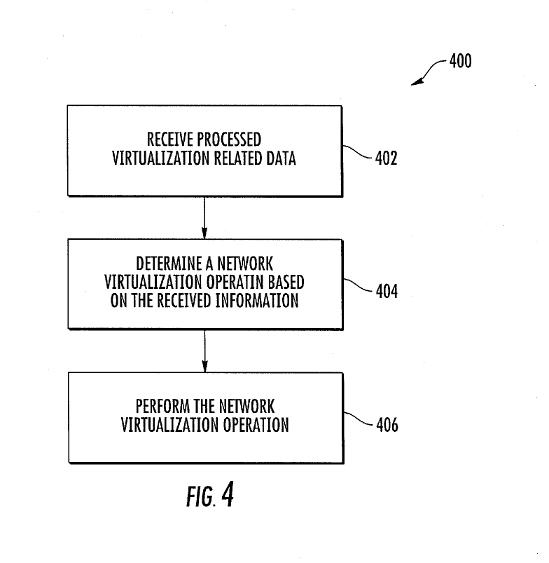

FIG. 4 is a flow chart depicting an exemplary method, generally designated 400, for using processed virtualization related data related to a telecommunications network for managing network virtualization according to an embodiment of the subject matter described herein. Referring to FIG. 4, in block 402, processed virtualization related data may be received by the Cloud XG virtualization orchestrator (VO) 104. For example, virtualization related information may be processed by the NFV information concentrator 102 and directed to the rules engine 132 of the Cloud XG VO 104.

In block 404, the rules engine 132 may determine a network virtualization operation to perform based on the received information. In some embodiments, the rules engine 132 may be connected to a rules database 142 which may be configured to provide network provision rules, a state database 138 which monitors and stores network state information, and a topology data database 140 which may supply network topology data to the rules engine 132. Network virtualization operation commands may be generated by the rules engine 132 based on the received processed virtualization related data, coupled with current network topology and state information. For example, service requests may be generated at the rules engine 132 for various applications to reallocate resources related to the telecommunications network to reallocate resources to mitigate the effects of possible network overload.

At block 406, the determined network operation may be performed by the virtualization orchestrator 104. In some embodiments, the new network virtualization operation generated by the rules engine 132 may be directed to various applications and products within the telecommunications network, via an application coordination interface module 130. For example, the application coordination interface module 130 may be a PCRF plugin module configured to interact with applications and products within the telecommunications network. The PCRF plugin may be used to control topology and provisioning configurations to the various network resources within the telecommunications network. In addition, the PCRF plugin may be configured to be a bi-directional interface module and supply network performance indicators such as processor and disk usage or network traffics back to the rules engine 132.

In some embodiments, the rules engine 132 may communicate the virtualization operation commands to network virtualization modules related to the telecommunications network. For example, network virtualization operations may be directed to an orchestration coordination interface module 124 configured to coordinate virtualization operations with another virtualization orchestrator. The other virtualization orchestrator may utilize network virtualization operations generated by the rules engine 132 to manage a different and/or larger cloud network. In other embodiments, the Cloud XG VO 104 may direct network virtualization operations to another telecommunications network via a cloud management interface module 134. The other telecommunications network may not have a virtualization orchestrator, and the cloud management interface module 134 may be configured to manage network resources related to that network. While the methods, systems, and computer readable media have been described herein in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims. It is understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for managing network virtualization, the method comprising:
at a virtualization orchestrator comprising a hardware processor and for managing virtual networks within a telecommunications network:
receiving virtualization related data from at least one of an information concentrator for collecting and analyzing virtualization related information and a source other than telecommunications network nodes;
determining a network virtualization operation based on the received data; and
performing the network virtualization operation.

2. The method of claim 1 wherein determining a network virtualization operation to perform comprises using a rules engine for analyzing the received data and identifying a network virtualization operation to be performed based on rules.

3. The method of claim 1 wherein determining a network virtualization operation comprises using information from at least one of:
a rules database for providing network virtualization operation rules;
a topology database for providing network topology information; and
a state database for maintaining network state information.

4. The method of claim 1 wherein receiving virtualization related data comprises receiving data via an interface module for receiving virtualization related data from an information concentrator.

5. The method of claim 1 wherein receiving virtualization related data comprises receiving processed virtualization related information from an information concentrator.

6. The method of claim 5 wherein receiving processed virtualization related information comprises receiving information that has been processed by performing at least one of:
filtering the processed virtualization related information;
applying an algorithm to the processed virtualization related information; and
detecting a characteristic pattern within the processed virtualization related information.

7. The method of claim 1 wherein receiving virtualization related data includes receiving at least one of:
system performance indicators;
cloud management information; and
external network information.

8. The method of claim 1 wherein performing the network virtualization operation comprises one of:
assigning at least one additional network resource to a network component; and
removing at least one network resource from a network component.

9. A system for managing network virtualization, the system comprising:
a virtualization orchestrator (VO) comprising hardware and for managing virtual networks within a telecommunications network, the VO including: a network interface for receiving virtualization related data; and a virtualization engine for determining a network virtualization operation based on the received information and for performing the network virtualization operation, wherein the received information is at least one of:
information received from an information concentrator for collecting and analyzing virtualization related information; and
information received from sources other than telecommunications network nodes.

10. The system of claim 9 wherein the virtualization engine includes a rules engine for analyzing the received information and identifying a network virtualization operation to be performed based on rules.

11. The system of claim 9 wherein the virtualization orchestrator further comprises at least one of:
a rules database for providing network virtualization operation rules;
a topology database for providing network topology information; and
a state database for maintaining network state information.

12. The system of claim 9 wherein the virtualization orchestrator includes an interface module configured for receiving virtualization related data from an information concentrator.

13. The system of claim 9 comprising an information concentrator for collecting and analyzing virtualization related information and providing processed virtualization related data to the virtualization orchestrator.

14. The system of claim 13 wherein analyzing the virtualization related information comprises at least one of:
filtering the virtualization related information;
applying an algorithm to the virtualization related information; and
detecting a characteristic pattern within the virtualization related information.

15. The system of claim 9 wherein the received information includes at least one of:
system performance indicators;
cloud management information; and
information from sources external to the network.

16. The system of claim 9 wherein the network virtualization operation comprises one of:
assigning at least one additional network resource to a network component; and
removing at least one network resource from a network component.

17. A non-transitory computer readable medium having stored thereon computer executable instructions embodied in a computer readable medium and when executed by a processor of a computer performs steps comprising:
at a virtualization orchestrator comprising a hardware processor and for managing virtual networks:
receiving virtualization related data from at least one of: an information concentrator for collecting and analyzing virtualization related information; and a source other than telecommunications network nodes;
determining a network virtualization operation based on the received data; and
performing the network virtualization operation.

18. The non-transitory computer readable medium of claim 17 wherein determining a network virtualization operation to perform comprises using a rules engine for analyzing the received data and identifying a network virtualization operation to be performed based on rules.

19. The non-transitory computer readable medium of claim 17 wherein determining a network virtualization operation comprises using information from at least one of:
a rules database for providing network virtualization operation rules;
a topology database for providing network topology information; and
a state database for maintaining network state information.

20. The non-transitory computer readable medium of claim 17 wherein receiving virtualization related data comprises receiving data via an interface module for receiving virtualization related data from an information concentrator.
